(19) United States
(12) Patent Application Publication
(10) Pub. No.: US 2023/0098959 A1
(43) Pub. Date: Mar. 30, 2023

(54) USE OF ALIPHATIC ISOCYANATE AS TOXIC FUME SUPRESSANT IN POLYURETHANE FOAMS

(71) Applicant: INDRESMAT BV, Geleen (NL)

(72) Inventor: Pablo Rodriguez Outón, Geleen (NL)

(73) Assignee: INDRESMAT BV, Geleen (NL)

(21) Appl. No.: 17/798,869

(22) PCT Filed: Feb. 8, 2021
(86) PCT No.: PCT/EP2021/052953

§ 371 Date: Aug. 10, 2022

(30) Foreign Application Priority Data
Feb. 10, 2020 (EP) 20382085.7

(51) Int. Cl. C08G 18/20; C08G 18/32; C08G 18/48; C08G 18/66

(52) U.S. Cl. CPC C08G 18/2063; C08G 18/3206; C08G 18/4829; C08G 18/6677; C08G 2110/0083

(57) ABSTRACT

The present invention relates to the field of polyurethane foams and the way to reduce the smoke and the toxic compounds created when the foam burns.

### FIELD OF THE INVENTION

The present invention relates to the field of fire safety in polyurethane foams and the way to reduce the smoke emission and related toxic compounds created when the foam burns.

### BACKGROUND OF THE INVENTION

Polyurethane foams are prepared from the reaction between a di-isocyanate or polyisocyanate and a di-alcohol or polyol component. Polyurethanes foams are playing a relevant role in many areas because of their wide range of physical and properties. Polyurethane foams can be classified into flexible foams mainly used in furniture, mattresses, automotive seats and rigid foams, mainly used as insulation and as structural materials.

However, polyurethanes foams are very flammable when exposed to fire, and even more relevant is when the polyurethane foam burns, thus releasing a large amount of toxic smoke. Inhalation of smoke is the leading cause of fire fatalities, but also a major contributor to fire related injuries, being the smoke emission (amount of smoke emitted) and its fume toxicity (harmfulness of the gases emitted) critical problems addressed by the present invention.

There are some documents describing polyurethane foams that include in the composition a compound defined as “smoke suppressant”. For example, the European patent application EP0354632A describes a foam polymer composition having resistance to flame exposure that comprises an inorganic filler material such as alumina trihydrate or sodium silicate wherein the foam shows low levels of smoke when the foam is burned. However, the inorganic fillers may not be soluble in polyol components, which results in a poor dispersion within the polymer matrix, thus lowering the technical properties.

Another patent document that describes inorganic filler like a toxic smoke reducer is the patent EP0010931 wherein it is described the use of cobalt, copper, nickel or manganese salt of an aliphatic or alicyclic monocarboxylic acid. The salt is included in the reaction mixture normally used in the formation of polyurethane composition. It is relevant to highlight that this document suggests that the reduced smoke generation results from the presence of metal salts.

The patent application WO2015/090953 describes a composition that comprises a thermoplastic polyurethane based on an aliphatic polyisocyanate and at least a phosphorous compound as flame retardant and a metal hydroxide. In this document there is not any teaching about toxic fume reduction.

The patent application U.S. Pat. No. 5,102,919 describes how the aliphatic dibasic ester added like an additive in a polyurethane-polyisocyanurate foam formulation, reduce the smoke generation. The foam formulation comprises an organic aromatic isocyanate, a polyol, a non- reactive flame-retardant additive, a catalyst and the smoke reducing mixture of aliphatic dibasic esters.

Thus, from what is known in the prior art, it is derived that the development of a polyurethane foam which improves the passive fire safety behaviour when burning, it is still of great interest.

### SUMMARY OF THE INVENTION

Polyurethane foams are formed from the reaction between isocyanate and hydroxyl group compounds which result in urethane groups. The process includes two reactions. The first one is the reaction between isocyanate groups and hydroxyl groups, which forms backbone urethane groups. The second one is the reaction between isocyanate group and water (known as the blowing agent) which forms carbamic acid, decomposing into amine and carbon dioxide gas in the form of bubbles.

Polyurethane foams exhibit excellent sealing, cushioning and vibration control features due to low compression property. They also are excellent insulating materials, but they offer poor safety during fires. The most critical technical limitation of conventional polyurethane foams is their extremely high toxic smoke when burning.

The present invention has as main object to provide polyurethane foams that show highly improved passive protection in case of fire. The main advantages and key differential factors of the foam of the present invention are its reduced flammability and low emission of non-toxic fumes when burning.

The most critical problem to be solved by the present invention is to avoid extreme toxicity of the fumes released by the polyurethane foams currently used. In addition, compared to related inventions within the state-of-art, the foam of the invention also avoids the fast burning and the high fire propagation speed of conventional polyurethanes foams when they are exposed to flames, releasing big amounts of smokes that decrease the oxygen content in the fire area causing asphyxia during a fire.

The foam of the invention drastically reduces the presence of toxic components in fumes, while simultaneously decreases the amount of smoke released, and decreases the flammability and fire propagation speed, thus dramatically increasing its fire safety.

Therefore, as first approach, the invention refers to the use of aliphatic isocyanate as a toxic fume suppressant in polyurethane foam, wherein the aliphatic isocyanate component is included in the polyurethane foam by reacting with at least a polyol compound.

The term “isocyanate component” means at least one isocyanate compound.

“Toxic fume suppressant” refers to the aliphatic isocyanate included in the polyurethane foam that results in toxic fume reduction when the foam is exposed to fire as compared to conventional PUR foams without aliphatic isocyanate.

The term “aliphatic isocyanate” refers to non-aromatic isocyanates, i.e. isocyanate in which the isocyanate groups are attached to saturated carbon atoms. Preferably, the isocyanate compound employed contains two isocyanate groups, however, isocyanate compounds containing more than two isocyanate groups are suitable for use in preparing the polyurethane foam. The aliphatic group is a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-40 carbon atoms. In certain embodiments, aliphatic groups contain 1-20 carbon atoms. In certain embodiments, aliphatic groups contain 3-20 carbon atoms. In certain embodiments, aliphatic groups contain 1-12 carbon atoms. In certain embodiments, aliphatic groups contain 1-8 carbon atoms. In certain embodiments, aliphatic groups contain 1-6 carbon atoms. In some embodiments, aliphatic groups contain 1-5 carbon atoms, in some embodiments, aliphatic groups contain 1-4 carbon atoms, in some embodiments aliphatic groups contain 1-3 carbon atoms, and in some embodiments aliphatic groups contain 1 or 2 carbon atoms. Examples of aliphatic isocyanate are: hexamethylene diisocyanate (HDI), pentamethylene diisocyanate (PDI), isophorone diisocyanate (IPDI), 4,4′-diisocyanatodicyclohexylmethane (H12MDI) and 2,4,4-trimethylhexamethylene diisocyanate (TMDI). The aliphatic isocyanate refers to monomer, dimer, oligomer and polymers containing two or more reactive isocyanate groups.

The term polyol refers to a compound having at least two alcohol or hydroxyl (—OH). The polyol can comprise at least one amine group. Examples of polyol are: functional polyether polyols, polyester polyols, polybutadiene polyols, natural oil polyols, aliphatic polyols. The aliphatic group is a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic.

The foam can be used as structural material, thermal and acoustic insulating material as well as cushioning material in various markets such as construction, household items, automotive and aerospace, thus providing increased passive fire safety.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a comparative chromatographic profile corresponding to the analysed samples.

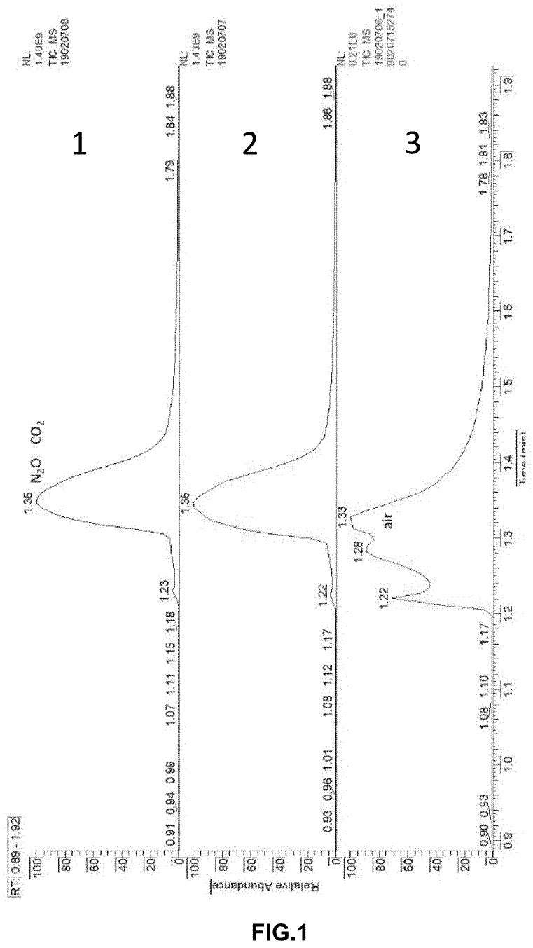

FIG. 2 shows a zoomed chromatographic profile between 2-6 min.

FIG. 3 shows a mass spectrum of peak at RT 1.39 min (N₂O or CO₂) and its comparison with NIST05 library.

FIG. 4 shows a mass spectrum of peak at RT 2.78 min (cyanogen) and its comparison with NIST05 library.

FIG. 5 shows a mass spectrum of peak at RT 3.47 min (propene) and its comparison with NIST05 library.

FIG. 6 shows a mass spectrum of peak at RT 4.20 min (methyl chloride) and its comparison with NIST05 library.

FIG. 7 shows a mass spectrum of peak at RT 4.35 min (Methylacetylene) and its comparison with NIST05 library

FIG. 8 shows a mass spectrum of peak at RT 4.73 min (Propadiene) and its comparison with NIST05 library.

FIG. 9 shows a flame test of the foam from the sample 2 used the Example 1 (left) versus the foam from the sample 3 used in the Example 1 (right).

### DETAILED DESCRIPTION OF THE INVENTION

As mentioned above, the approach of the present invention relates to the use of aliphatic isocyanate as a fume toxic suppressant in polyurethane foam, wherein the aliphatic isocyanate component is included in polyurethane foam by reacting with at least one polyol compound.

The polyurethane foam has an absence of halogenated flame retardants and inorganic fillers and phosphate-based flame retardants.

The present invention also relates to the use of aliphatic isocyanate as a toxic fume suppressant and a flame retardant in polyurethane foam, wherein the aliphatic isocyanate component is included in the polyurethane foam by reacting with at least one polyol compound.

Preferably the isocyanate component is selected from an isocyanate component that contains one to five isocyanate compounds, these compounds are the same or different.

In a particular embodiment the aliphatic polyisocyanate is selected from: hexamethylene diisocyanate (HDI), pentamethylene diisocyanate (PDI), isophorone diisocyanate (IPDI), 4,4′-diisocyanatodicyclohexylmethane (H12MD1) and 2,4,4-trimethylhexamethylene diisocyanate (TMDI).

### EXAMPLE 1

In the present Example three samples were analysed.

Sample 1 (aliphatic sample): fumes recollected after burning polyurethane foam obtained by reacting aliphatic polyisocyanate and polyol compounds. The aliphatic polyisocyanate used was pentamethylene diisocyanate (PDI). The polyol compounds were trifunctional polyether polyol based on glycerol (25%), difunctional polyether polyol based on 1,3-propanediol (5%), 1,4-butanediol (5%) and triethylenediamine (1%) as catalys. Also 0.2% of blowing agent (water) was added. The mixing ratio polyol/iso was b 65/35

Sample 2 (aromatic sample): fumes recollected after burning polyurethane foam obtained by reacting aromatic isocyanate and polyol compounds. The aromatic polyisocyanate used was diphenylmethane diisocyanate. trifunctional polyether polyol based on glycerol (10%), difunctional polyether polyol based on 1,3-propanediol (30%), 1,4-butanediol (10%) and triethylenediamine (0.5%) as catalyst. Also 0.2% of blowing agent (water) was added. The mixing ratio polyol/iso was 50/50.

Sample 3: (control): lab air room from where the combustion tests were performed.

Tests performed: Screening by GC/MS

Analytical methodology Sample preparation: direct introduction Analytical determination: Gas chromatography-mass spectrometry (GC/MS) Equipment used:

Column: SupelQ-Plot (30 m×0.32 mm)

Injector temperature: 200° C.

Mode: Split / Split ratio: 20:1/Injection volume: 0.6 ml

Temperature programme: 30° C. (6 min)@10° C./min until 120° C. (1 min)

Interface temperature: 250° C. / Ionization source temperature: 230° C.

Ionization mode: electron impact, SCAN mode (29-250 amu)

Instrumentation: Trace Gas chromatograph coupled to a DSQII mass spectrometer (ThermoFisher Scientific)

Carrier gas: Helium flow 1 ml/min

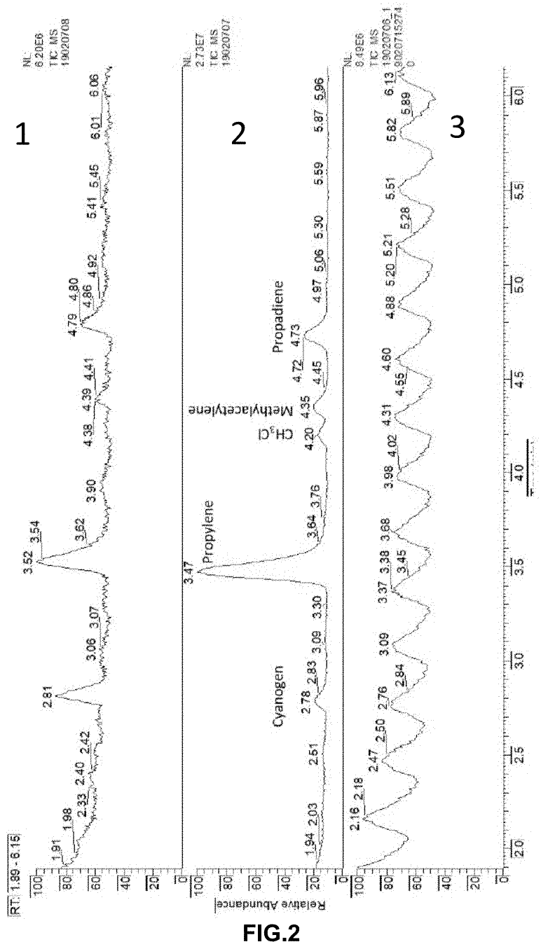

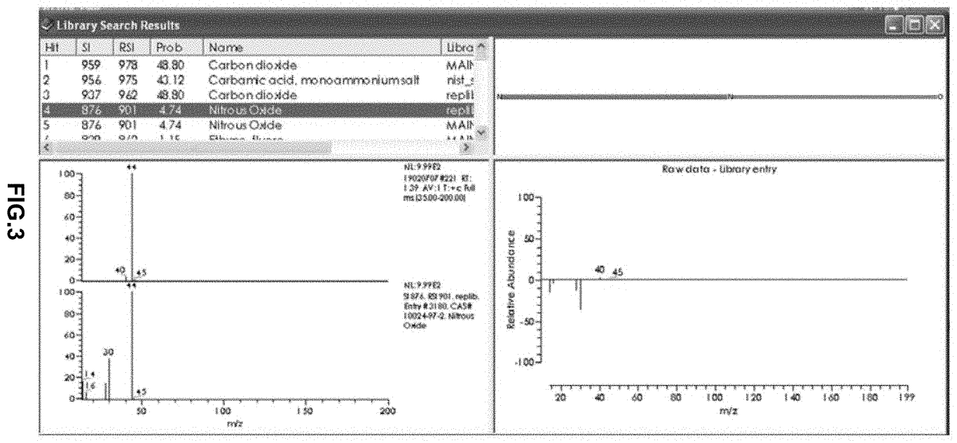

FIGS. 2-3 illustrates that the sample 2 (aromatic sample) shows the presence of peaks corresponding to propylene and propadiene, which are olefins (therefore extremely flammable and toxic per se). However, the sample 1 (aliphatic sample) does not show these peaks, clear evidence that the toxicity of smoke is lower as it does not contain such extremely flammable and toxic compounds.

The results showed by the gas chromatograph were confirmed by the mass spectrum.

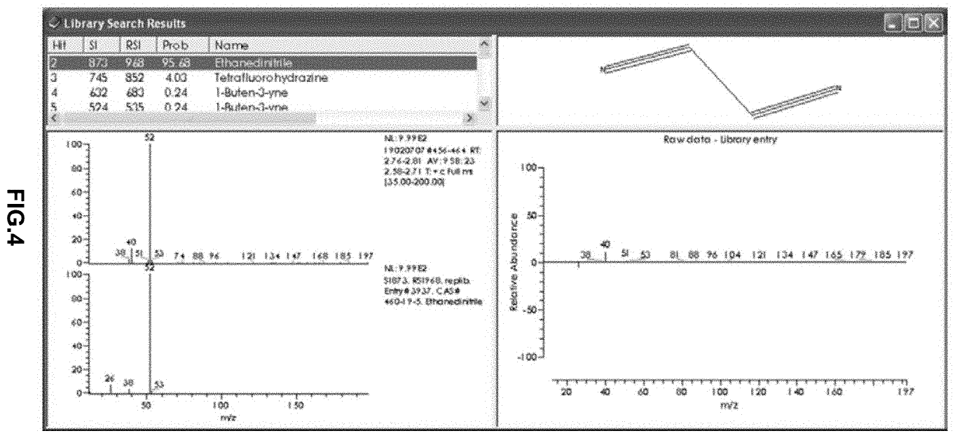

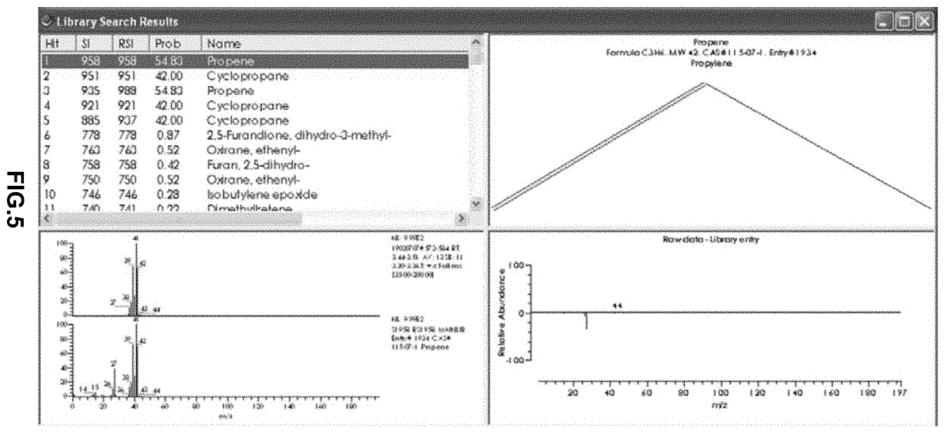

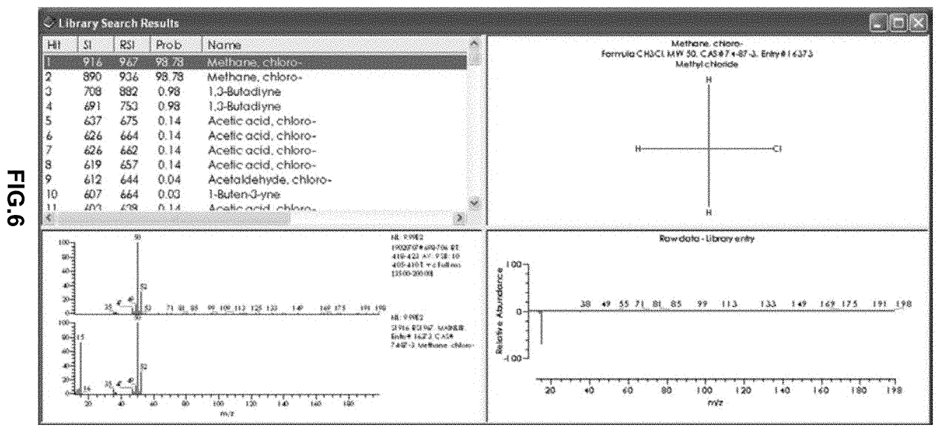

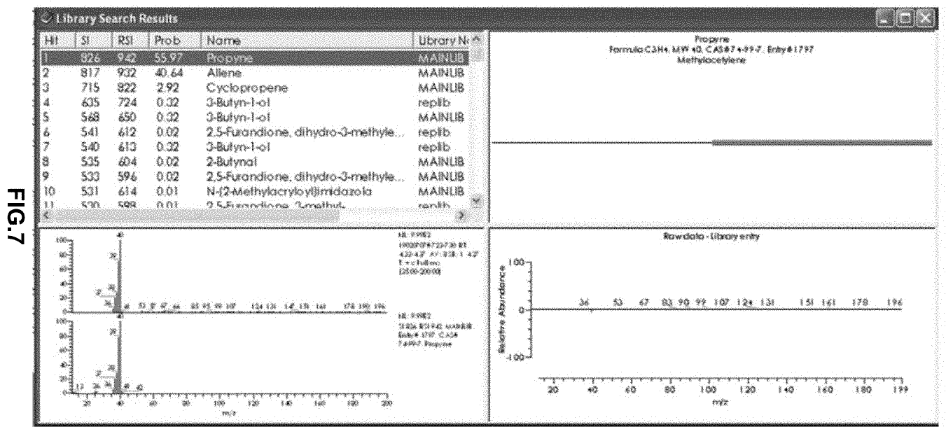

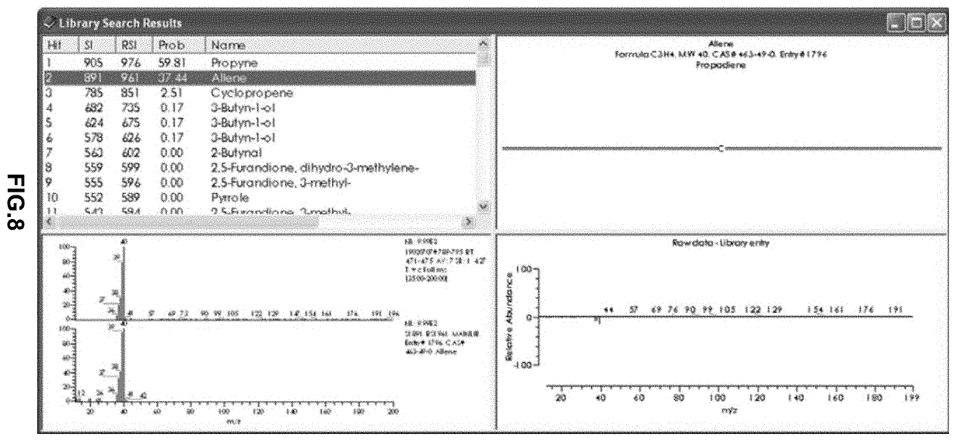

The FIGS. 3-8 show the mas spectrum that confirm:

the peak at RT 1.39 min is N₂O;

the peak at RT 2.78 min is cyanogen;

the peak at RT 3.47 min is propene;

the peak at RT 4.20 min is methyl chloride;

the peak at RT 4.35 min is Methylacetylene;

the peak at RT 4.73 min is propadiene.

Due to this it is confirmed that including aliphatic polyisocyanate in polyurethane foam implies that the foam is less flammable and with less spread to fire and also with much less toxicity in the absence of olefins (evidenced in GC-MS analysis).

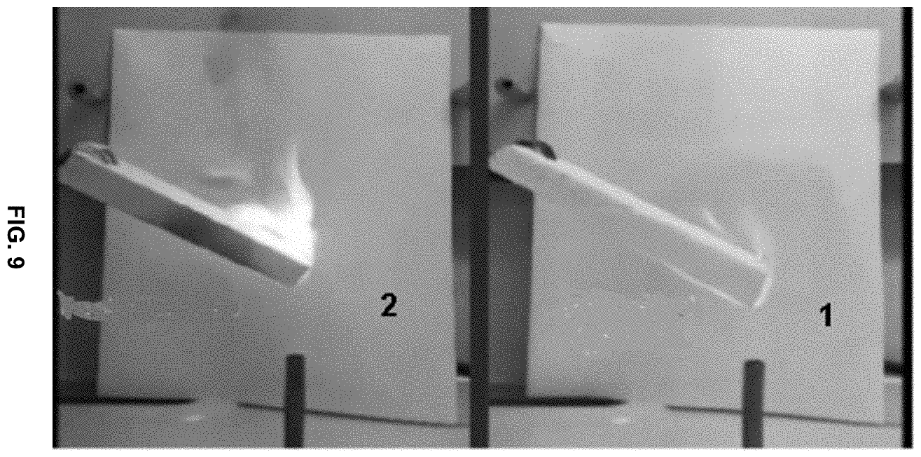

FIG. 9 shows the foam of sample 2 (left) and the foam of sample 1 (right) burning. The aromatic foam shows high amount of dark smokes, that means toxic smoke and fast ignition. The foam of sample 1 (right) shows very low emission of white (non toxic) smoke and a retarded ignition.

1. A method comprising:
suppressing a toxic fume in polyurethane foam with an aliphatic isocyanate, wherein the aliphatic isocyanate component is included in the polyurethane foam by reacting with at least one polyol compound.

2. The method of claim 1, further comprising retarding a flame in polyurethane foam with the aliphatic isocyanate.

3. The method of claim 1, wherein the polyurethane foam has an absence of halogenated flame retardants and inorganic fillers and phosphate-based flame retardants.

4. The method of claim 1, wherein the aliphatic isocyanate component is selected from an isocyanate component that contains one to five isocyanate compounds, these compounds are the same or different.

5. The method of claim 1, wherein the aliphatic polyisocyanate is selected from: hexamethylene diisocyanate (HDI), pentamethylene diisocyanate (PDI), isophorone diisocyanate (IPDI), 4,4′-diisocyanatodicyclohexylmethane (H12MDI) and 2,4,4-trimethylhexamethylene diisocyanate (TMDI).
